(19) United States
(12) Patent Application Publication
(10) Pub. No.: US 2017/0061479 A1
(43) Pub. Date: Mar. 2, 2017

(54) AUTOMATED MESSAGE INTROSPECTION AND OPTIMIZATION USING COGNITIVE SERVICES

(71) Applicant: INTERNATIONAL BUSINESS MACHINES CORPORATION, ARMONK, NY (US)

(72) Inventors: Rahul P. Akolkar, Austin, TX (US); Srijith N. Prabhu, Austin, TX (US); Joseph L. Sharpe, III, Loveland, OH (US); Bruce R. Slawson, Palmdale, CA (US); Jagan Mohan Rao Vujjini, Durham, NC (US)

(21) Appl. No.: 14/840,638

(22) Filed: Aug. 31, 2015

(51) Int. Cl. G06Q 30/02; G06N 99/00; G06N 5/04; G06Q 50/00

(52) U.S. Cl. CPC G06Q 30/0254; G06Q 30/0269; G06Q 50/01; G06N 99/005; G06N 5/04

(57) ABSTRACT

Software that utilizes cognitive services to analyze proposed communications and determine their predicted acceptance by a target audience. The software performs the following operations: (i) receiving a communication from a sender; (ii) determining a demography of a target audience for the communication using natural language processing; (iii) analyzing a set of data sources to determine a predicted amount of acceptance of the communication by the target audience based, at least in part, on the target audience's determined demography; and (iv) identifying a set of adjustments to the communication based, at least in part, on a predicted amount of improvement to the predicted amount of acceptance of the communication by the target audience, wherein the set of adjustments utilizes one or more synonyms to replace one or more words in the communication.

### BACKGROUND

The present invention relates generally to the field of computer messaging, and more particularly to optimizing computer messages for target audiences.

Computers are commonly used to send messages between human beings. For example, instant messaging, email, and social media posts are known ways for delivering human-readable messages from one person to another, or from one person to many. In some cases, computer messaging is utilized by businesses to reach target audiences, for marketing and/or advertising purposes, for example.

Cognitive computing is a field of artificial intelligence which generally attempts to reproduce the behavior of the human brain. Cognitive systems can perform a wide variety of tasks utilizing known artificial intelligence-based concepts such as natural language processing, information retrieval, knowledge representation, automated reasoning, and machine learning.

### SUMMARY

According to an aspect of the present invention, there is a method, computer program product and/or system that performs the following operations (not necessarily in the following order): (i) receiving, by one or more processors, a communication from a sender; (ii) determining, by one or more processors, a demography of a target audience for the communication using natural language processing; (iii) analyzing, by one or more processors, a set of data sources to determine a predicted amount of acceptance of the communication by the target audience based, at least in part, on the target audience's determined demography; and (iv) identifying, by one or more processors, a set of adjustments to the communication based, at least in part, on a predicted amount of improvement to the predicted amount of acceptance of the communication by the target audience, wherein the set of adjustments utilizes one or more synonyms to replace one or more words in the communication.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system;

FIG. 4 is a screenshot view generated by the first embodiment system;

FIG. 5 is a diagram depicting a system for selecting messages according to an embodiment of the present invention; and

FIG. 6 is a diagram showing an example identification of a target audience according to an embodiment of the present invention.

### DETAILED DESCRIPTION

When communicating via computers, incorrect or imprecise language in a communication can result in poor responses from the communication's target audience. Embodiments of the present invention utilize cognitive services to analyze proposed communications and determine their predicted acceptance by a target audience. Further, some embodiments recommend adjustments to proposed communications in order to improve their effectiveness and resonance with their target audience. This Detailed Description section is divided into the following sub-sections: (i) The Hardware and Software Environment; (ii) Example Embodiment; (iii) Further Comments and/or Embodiments; and (iv) Definitions.

### I. THE HARDWARE AND SOFTWARE ENVIRONMENT

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

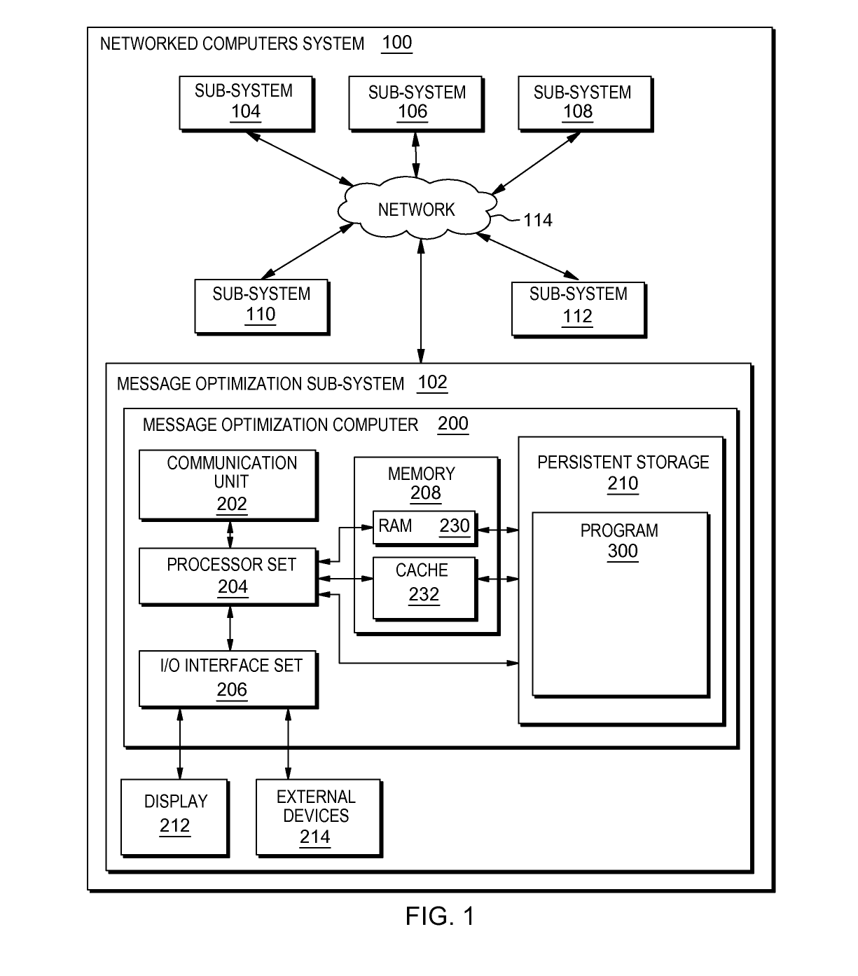

An embodiment of a possible hardware and software environment for software and/or methods according to the present invention will now be described in detail with reference to the Figures. FIG. 1 is a functional block diagram illustrating various portions of networked computers system 100, including: message optimization sub-system 102; message optimization sub-systems 104, 106, 108, 110, 112; communication network 114; message optimization computer 200; communication unit 202; processor set 204; input/output (I/O) interface set 206; memory device 208; persistent storage device 210; display device 212; external device set 214; random access memory (RAM) devices 230; cache memory device 232; and program 300.

Sub-system 102 is, in many respects, representative of the various computer sub-system(s) in the present invention. Accordingly, several portions of sub-system 102 will now be discussed in the following paragraphs.

Sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine readable instructions and/or data that is used to create, manage and control certain software functions that will be discussed in detail, below, in the Example Embodiment sub-section of this Detailed Description section.

Sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to sub-system 102. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with message optimization computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. EXAMPLE EMBODIMENT

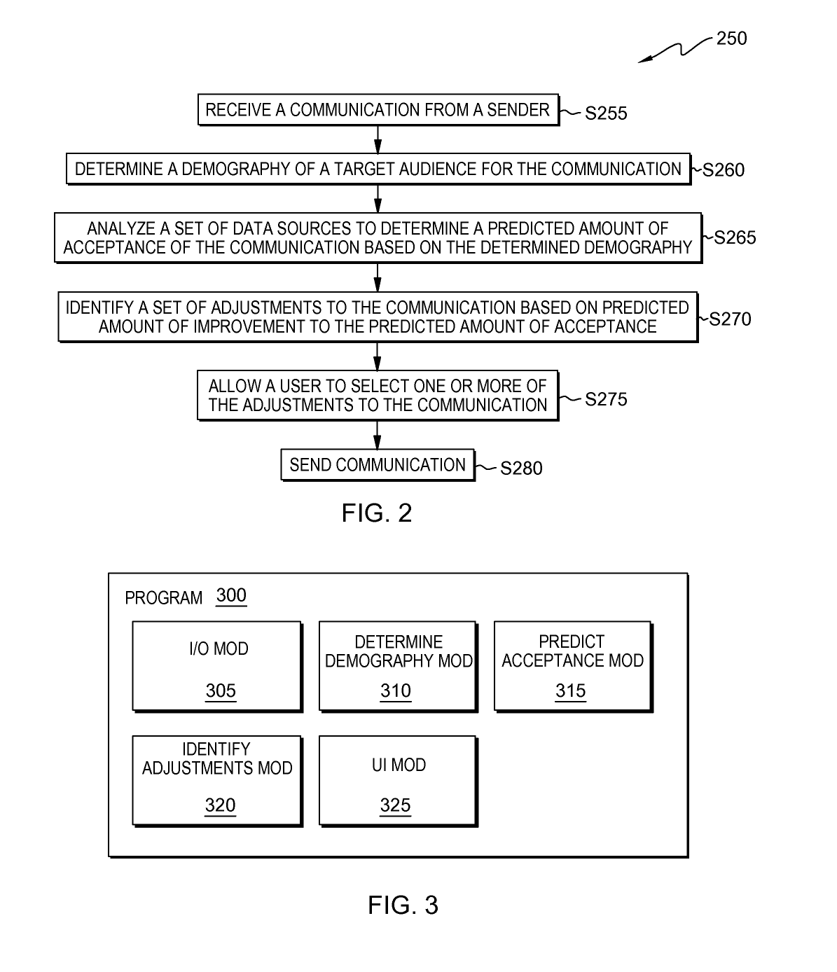

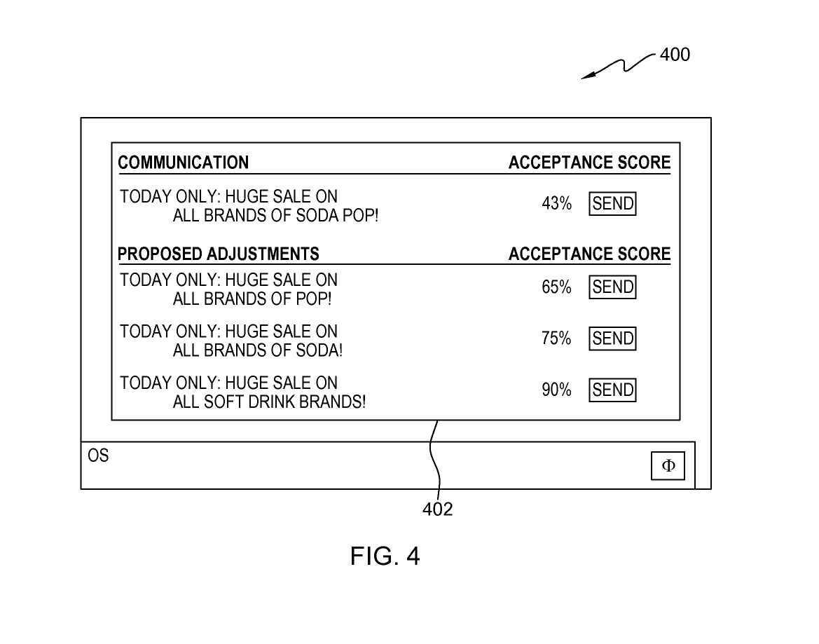

FIG. 2 shows flowchart 250 depicting a method according to the present invention. FIG. 3 shows program 300 for performing at least some of the method operations of flowchart 250. This method and associated software will now be discussed, over the course of the following paragraphs, with extensive reference to FIG. 2 (for the method operation blocks) and FIG. 3 (for the software blocks). It should be noted that this example embodiment (also referred to in this sub-section as the “present embodiment,” the “present example,” the “present example embodiment,” and the like) is used herein for example purposes, in order to help depict the scope of the present invention. As such, other embodiments (such as embodiments discussed in the Further Comments and/or Embodiments sub-section, below) may be configured in different ways or refer to other features, advantages, and/or characteristics not fully discussed in this sub-section. Furthermore, although program 300 is shown in FIG. 1 as being located in persistent storage 210 of message optimization computer 200 of message optimization sub-system 102, it should be recognized that in certain embodiments, some or all of program 300 may reside in other locations, such as in sub-systems 104, 106, 108, 110, and/or 112 of networked computers system 100.

Processing begins at operation S255, where input/output (“I/O”) module (“mod”) 305 receives a communication from a sender. The received communication is ultimately (or at least provisionally) intended to be sent to one or more recipients, but is first received by mod 305 in order to be analyzed by the method described herein. The communication may be any natural language communication capable of being ingested by natural language processing (NLP) components of a cognitive system. Further, the communication may be any of a wide variety of communication types, including, but not limited to: an email message, an SMS message, an instant message, and/or a social media message. In the present embodiment, the communication (sometimes also referred to as a “message”) is a social media post from a company that is selling products. More specifically, in the present example, the sender is a business that owns a convenience store, and the communication relates to a one-day sale on soft drinks (or carbonated beverages). In this embodiment, the communication is intended for a plurality of recipients: the convenience store's potential customers. The communication, as received, reads “Today Only: HUGE sale on all brands of soda pop!”

Processing proceeds to operation S260, where determine demography mod 310 determines a demography of a target audience for the communication using natural language processing (“NLP”). As mentioned above, in the present example, the intended recipients of the communication are potential customers of the sender's convenience store. As such, the target audience for which mod 310 determines a demography is the set of potential customers. The demography is determined by using NLP to extract demographic information from information relating to the target audience of the communication (such as social media posts written by or about the target audience). Some examples of potential demographic information that may be included in the demography include, but are not limited to: age, gender, ethnicity, locale, enthusiast, purchaser, sports fan, religion, interest in social media trends, and commonly followed social media entities. In the present example embodiment, although the demography determined by mod 310 is a complex one with many types of demographic information, the demographic information worth noting is that the target audience resides in a particular geographic region—that is, the region within fifteen (15) miles of the sender's convenience store.

As mentioned above, demography mod 310 uses natural language processing (NLP) to determine the demography of the target audience. NLP may be utilized in a wide variety of ways. For example, in some embodiments, mod 310 utilizes a user modeling service that uses linguistic analytics to extract cognitive and social characteristics from communications relating to (or generated by) the target audience. For a discussion of user modeling services that may be utilized in this operation, see the Further Comments and/or Embodiments sub-section of this Detailed Description.

Processing proceeds to operation S265, where predict acceptance mod 315 analyzes a set of data sources to determine a predicted amount of acceptance of the communication by the target audience based on the target audience's determined demography. Stated another way, in this operation, mod 315 determines how likely it is that the target audience will accept (for example, respond positively to) the communication, based on data sources relating to the target audience. The data sources may include any relevant source of information relating to the target audience, including, for example, email messages, short message service (SMS) messages, instant messages, social media posts, forum posts, blog posts, and personal writings. In the present example embodiment, mod 315 analyzes the social media posts of individuals within the particular geographic region previously identified by mod 310 (that is, people within 15 miles of the sender's convenience store). According to the analyzed data, mod 315 determines that 43% of the determined demography is predicted to be accepting of the received message (“Today Only: HUGE sale on all brands of soda pop!”).

Predict acceptance mod 315 may utilize a wide variety of tools and services to determine a predicted amount of acceptance of the communication. For example, in some embodiments, mod 315 utilizes a cognitive-based message resonance service that analyzes the communication and scores it based on how well it is likely to be received by the specific target audience. For a discussion of message resonance services that may be utilized in this operation, see the Further Comments and/or Embodiments sub-section of this Detailed Description.

Processing proceeds to operation S270, where identify adjustments mod 320 identifies a set of adjustments to the communication based on a predicted amount of improvement to the predicted amount of acceptance. A wide variety of potential adjustments may be identified and/or proposed. In some embodiments, the set of adjustments may utilize one or more synonyms to replace one or more words in the communication. For example, in the present example embodiment, mod 320 retrieves synonyms of the words “soda pop” to determine whether they may increase the target audience's predicted acceptance of the communication. In this example, mod 320 sends adjusted communications (that is, communications including synonyms of “soda pop”) back to mod 315 to determine their respective amounts of acceptance amongst the target audience. The resulting acceptance scores lead mod 320 to identify the following potential adjustments to the communication (shown with their respective acceptance scores): (i) “Today Only: HUGE sale on all brands of pop!”, 65% Acceptance; (ii) “Today Only: HUGE sale on all brands of soda!”, 75% Acceptance; and (iii) “Today Only: HUGE sale on all soft drink brands!”, 90% Acceptance.

As indicated in the previous paragraph, in some embodiments, the identification of adjustments to the communication is based on retrieving synonyms for words in the communication and determining if those synonyms may generate higher acceptance scores. In some embodiments the adjustments are further identified and/or candidate adjustments are further assessed utilizing statistical methods and/or machine learning. For example, in an embodiment, the retrieved synonyms are checked against a message resonance API (produced, for example, by a message resonance service, discussed below).

Processing proceeds to operation S275, where user interface (“UI”) mod 325 provides a user interface to allow a user to select one or more of the adjustments to the communication and/or modify aspects of the demography. Screenshot 400 (see FIG. 4) depicts an example user interface according to the present example embodiment. As shown in screen portion 402 of screenshot 400, UI mod 325 displays the received communication and the proposed adjustments (mentioned above), along with their corresponding acceptance scores. Screen portion 402 also includes corresponding “SEND” buttons for each of the communications, allowing the user (in this case, the person managing the convenience store's social media account) to send the respective communication through various social media channels. In other examples (not shown), screen portion 402 may also show tools for modifying aspects of the demography to better tailor the communication to the target audience. For example, although the originally determined demography was based on a target audience with a geographic location within 15 miles of the convenience store, the user may want to adjust the demography to include a larger or smaller region, or to focus primarily on a certain gender or age group. It should be recognized, however, that these are only examples, and that UI mod 325 may provide any type of known (or yet to be known) user interface for allowing a user to modify parameters associated with the previously discussed operations and/or select an original or adjusted communication to send.

Processing proceeds to operation S280, where I/O mod 305 sends the communication to its intended audience. That is, the selected communication (either the originally received communication or an adjusted communication) is sent to the one or more recipients that the received communication was originally intended for. In the present example, the user selects the communication with the highest acceptance score (“Today Only: HUGE sale on all soft drink brands!”), and mod 305 sends the communication using the convenience store's social media accounts on various social media channels.

### III. FURTHER COMMENTS AND/OR EMBODIMENTS

Some embodiments of the present invention recognize the following facts, potential problems and/or potential areas for improvement with respect to the current state of the art: (i) in many cases, targeting specific audiences via social media platforms is not enough to ensure customer engagement; and/or (ii) incorrect language in a social media and/or marketing message to a specific audience can result in a poor response.

Some embodiments of the present invention may include one, or more, of the following features, characteristics and/or advantages: (i) increasing the effectiveness of social media and/or marketing messages; (ii) generating strong levels of customer engagement with social media and/or marketing messages; (iii) improving social media messages using cognitive analysis of a proposed message; (iv) determining a final massage using strength indicators from an analysis service for each word in a message; (v) dynamically identifying target audiences for a message; (vi) determining the strength of a message for a specific target audience; and/or (vii) indicating the strength of a message compared to previously drafted messages.

Some embodiments of the present invention utilize a probabilistic system for analyzing natural language to generate solutions—an improvement over known deterministic-based approaches. Systems according to these embodiments may be built based on concepts of artificial intelligence such as natural language processing (NLP), information retrieval, knowledge representation, automated reasoning, and machine learning.

Certain embodiments of the present invention utilize a user modeling service (sometimes also referred to as a “personality insights” service) that uses linguistic analytics to extract cognitive and social characteristics from communications made available by a user. Some examples of communications that can be analyzed include email messages, text (for example, SMS) messages, social media posts, and forum posts. By deriving cognitive and social preferences from these communications, the user modeling service helps users to understand, connect to, and communicate with other people (for example, potential customers) on a more personalized level. The user modeling service can automatically infer portraits (or “models”) of individuals that reflect their personality characteristics. Some examples of models based on personality characteristics could include, for example: (i) a “Big Five” model based on dimensions of agreeableness, conscientiousness, extraversion, emotional range, and openness; (ii) a “Needs” model based on dimensions of excitement, harmony, curiosity, ideal, closeness, self-expression, liberty, love, and practicality; and/or (iii) a “Values” model based on dimensions of self-transcendence (helping others), conservation (tradition), taking pleasure in life, self enhancement (achieving success), and open to change (excitement). In an example embodiment, the user modeling service receives a file (for example, a plain text file, an HTML file, or a JSON file) containing social media communications from an individual. After performing linguistic analytics on the received file, the user modeling service outputs a file (for example, a JSON or CSV file) providing a percentage (or percentile) and a sampling error for each dimension of the “Big Five” model (referenced above) to indicate the extent to which the individual's writing exhibits each dimension. Additionally, if the input includes timestamps, the user modeling service may provide a summary of the individual's writing habits with respect to day of week and/or time of day.

Certain embodiments of the present invention utilize a message resonance service that analyzes draft content (for example, social media and/or marketing content) and scores how well the content is likely to be received by a specific target audience. The analysis may be based on content that has been written by the target audience itself—for example, fans of a specific sports team, or new parents. The service may be adapted to any of a wide variety of possible domains for which a set of users can be identified. In an example embodiment, the message resonance service receives a message as input. After analyzing the message, the message resonance service outputs the following quantitative measures: (i) a number of social media favorites or re-posts that were generated by content similar to the message; (ii) a frequency with which content similar to the message appears in social media; (iii) a time period during which social favorites or re-posts based on content similar to the message are likely to appear. Additionally, the message resonance service may provide a message resonance score (for example, between 0 and 99) indicating an amount of resonance that the message may have for a given target audience.

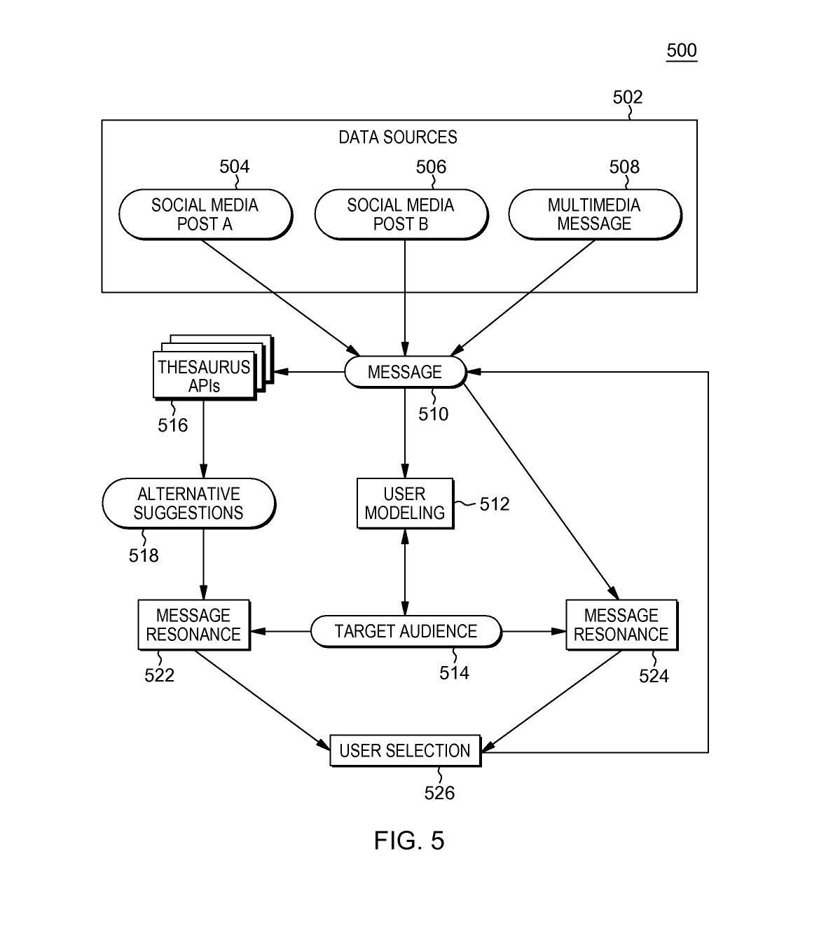

Diagram 500 (see FIG. 5) depicts a system for selecting messages according to an embodiment of the present invention. As shown in FIG. 5, various data sources 502 are used as input, including social media post A 504, social media post B 506, and multimedia message 508. Message 510 is selected from one of the data sources 502, and the message is passed along to user modeling service 512. User modeling service 512 uses linguistic analytics to determine target audience 514 for message 510, which includes a psycholinguistic profile. For that psycholinguistic profile, the message resonance for message 510 is determined by message resonance service 524. Similarly, the message resonance for the psycholinguistic profile is also determined by message resonance service 522. However, instead of receiving message 510 as input, message resonance service 522 receives possible alternative message suggestions 518 based on thesaurus APIs 516. Once the message resonance has been determined for both the original message 510 (by message resonance service 524) and for one or more alternative message suggestions 518 (by message resonance service 522), a user select and/or modifies one of the messages (either the original message 510 or an alternative message suggestions 518) for publication (see user selection 526). In many cases, the respective resonances for original message 510 and alternative message suggestions 518 are represented in the form of resonance scores, providing the user with a simple way of identifying the resonance to the target audience 514 for a given message. Furthermore, it should be noted that in some embodiments, message resonance service 522 and message resonance service 524 are the same service.

In some embodiments, filters are used to filter original message 510 and alternative message suggestions 518 prior to inputting them into message resonance services 524 and 522, respectively. For example, in one embodiment, a stop filter is used, where the stop filter may, for example, filter out common and/or inappropriate words (and their synonyms). In another embodiment, a word filter is used, where the word filter may, for example, filter out words and/or synonyms with low scores.

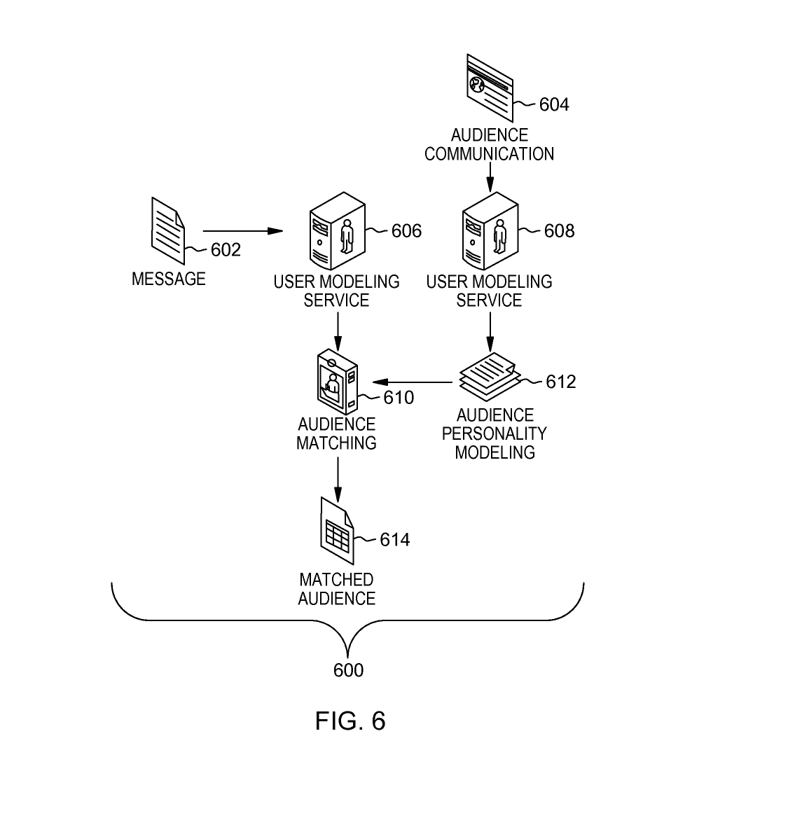

Diagram 600 (see FIG. 6) shows an example identification of a target audience (for example, target audience 514) according to an embodiment of the present invention. As shown in FIG. 6, user modeling services 606 and 608 receive message 602 and audience communication 604, respectively. Although user modeling services 606 and 608 are two distinctly separate services in this embodiment, it should be noted that some embodiments may use a single user modeling service (or many user modeling services) to perform the same functions.

As used in this example, message 602 is a message that a user of the system depicted in FIG. 6 wishes to deliver to an audience. Audience communication 604 is an example set of communications from a plurality of audiences, which will be used for matching the message to a particular audience.

User modeling service 606 and user modeling service 608 generate models for message 602 and audience communication 604, respectively. Once the model for audience communication 604 is generated, it is added to audience personality modeling database 612. In many cases, additional models for additional audience communications are generated, such that audience personality modeling database 612 includes models of a plurality of audiences that have been processed with user modeling. The modeled plurality of audiences is then compared to the modeled message 602 in audience matching 610, where the system finds an audience that most closely matches message 602. The result is matched audience 614, which acts as the target audience (for example, target audience 514) for one or more message selection processes of the present invention.

Some embodiments of the present invention include a method for tailoring communications comprising: (i) receiving a communication (for example, a message, text, audio, video) from a sender to be targeted to others; (ii) applying natural language processing (NLP) or social media conventions to the communication to determine a demography of a target audience; (iii) analyzing data sources (for example, social networks) to characterize aspects of the communication predicted to improve the communication based on the demography of the target audience; and (iv) identifying adjustments to the communication based on a predicted acceptance of the target audience. In certain embodiments, the demography is selected from a group consisting of age, gender, ethnic, locale, enthusiast, product buyer, sports fan, religious, interest in social media trends, and following common social media entities. In certain embodiments, the data source are selected from a group consisting of email, short messages services (SMS), text messages, instant messages (IM), tweets, forum posts, personal writings, authored publications, and etc.

Some embodiments further comprise utilizing analytic analysis (for example, statistical methods) and artificial intelligence (AI) and/or machine learning to assess changes to the communication. In some embodiments, the changes utilize synonyms (for example, concept expansions) to replace words in the communication. Some embodiments further comprise providing a user interface (UI) to allow a user to change the communication, modify aspects of the demography, and select replacement words.

### IV. DEFINITIONS

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

User/subscriber: includes, but is not necessarily limited to, the following: (i) a single individual human; (ii) an artificial intelligence entity with sufficient intelligence to act as a user or subscriber; and/or (iii) a group of related users or subscribers.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

Natural Language: any language used by human beings to communicate with each other.

Natural Language Processing: any derivation of meaning from natural language performed by a computer.

What is claimed is:

1. A computer-implemented method comprising:
receiving, by one or more processors, a communication from a sender;
determining, by one or more processors, a demography of a target audience for the communication using natural language processing;
analyzing, by one or more processors, a set of data sources to determine a predicted amount of acceptance of the communication by the target audience based, at least in part, on the target audience's determined demography; and
identifying, by one or more processors, a set of adjustments to the communication based, at least in part, on a predicted amount of improvement to the predicted amount of acceptance of the communication by the target audience.

2. The method of claim 1, wherein the demography of the target audience is based on at least one of the following: interest in social media trends and commonly followed social media entities.

3. The method of claim 1, wherein the demography of the target audience is based on at least one of the following: locale and purchasing history.

4. The method of claim 1, wherein the set of data sources includes at least one of the following: email, short message service (SMS) messages, instant messages, social media posts, forum posts, and blog posts.

5. The method of claim 1, further comprising:
assessing, by one or more processors, the set of adjustments to the communication using statistical methods and/or machine learning.

6. The method of claim 1, wherein the set of adjustments utilizes one or more synonyms to replace one or more words in the communication.

7. The method of claim 1, further comprising:
providing, by one or more processors, a user interface to allow a user to adjust the communication and modify aspects of the demography.

8. A computer program product comprising a computer readable storage medium having stored thereon:
first program instructions programmed to receive a communication from a sender;
second program instructions programmed to determine a demography of a target audience for the communication using natural language processing;
third program instructions programmed to analyze a set of data sources to determine a predicted amount of acceptance of the communication by the target audience based, at least in part, on the target audience's determined demography; and
fourth program instructions programmed to identify a set of adjustments to the communication based, at least in part, on a predicted amount of improvement to the predicted amount of acceptance of the communication by the target audience.

9. The computer program product of claim 8, wherein the demography of the target audience is based on at least one of the following: interest in social media trends and commonly followed social media entities.

10. The computer program product of claim 8, wherein the demography of the target audience is based on at least one of the following: locale and purchasing history.

11. The computer program product of claim 8, wherein the set of data sources includes at least one of the following: email, short message service (SMS) messages, instant messages, social media posts, forum posts, and blog posts.

12. The computer program product of claim 8, further comprising:
fifth program instructions programmed to assess the set of adjustments to the communication using statistical methods and/or machine learning.

13. The computer program product of claim 8, wherein the set of adjustments utilizes one or more synonyms to replace one or more words in the communication.

14. The computer program product of claim 8, further comprising:
fifth program instructions programmed to provide a user interface to allow a user to adjust the communication and modify aspects of the demography.

15. A computer system comprising:
a processor(s) set; and
a computer readable storage medium;
wherein:
the processor set is structured, located, connected and/or programmed to run program instructions stored on the computer readable storage medium; and
the program instructions include:
first program instructions programmed to receive a communication from a sender;
second program instructions programmed to determine a demography of a target audience for the communication using natural language processing;
third program instructions programmed to analyze a set of data sources to determine a predicted amount of acceptance of the communication by the target audience based, at least in part, on the target audience's determined demography; and
fourth program instructions programmed to identify a set of adjustments to the communication based, at least in part, on a predicted amount of improvement to the predicted amount of acceptance of the communication by the target audience.

16. The computer system of claim 15, wherein the demography of the target audience is based on at least one of the following: locale and purchasing history.

17. The computer system of claim 15, wherein the set of data sources includes at least one of the following: email, short message service (SMS) messages, instant messages, social media posts, forum posts, and blog posts.

18. The computer system of claim 15, wherein the program instructions further include:
fifth program instructions programmed to assess the set of adjustments to the communication using statistical methods and/or machine learning.

19. The computer system of claim 15, wherein the set of adjustments utilizes one or more synonyms to replace one or more words in the communication.

20. The computer system of claim 15, wherein the program instructions further include:
fifth program instructions programmed to provide a user interface to allow a user to adjust the communication and modify aspects of the demography.
